(19) United States
(12) Patent Application Publication
(10) Pub. No.: US 2026/0036856 A1
(43) Pub. Date: Feb. 5, 2026

(54) LIQUID CRYSTAL DISPLAY DEVICE AND MANUFACTURING METHOD THEREFOR

(71) Applicant: Sharp Display Technology Corporation, Kameyama City (JP)

(72) Inventors: Hideki KITAGAWA, Kameyama City (JP); Yoshimasa CHIKAMA, Kameyama City (JP); Masamitsu YAMANAKA, Kameyama City (JP)

(21) Appl. No.: 19/270,597

(22) Filed: Jul. 16, 2025

(30) Foreign Application Priority Data
Aug. 1, 2024 (JP) 2024-125655

(51) Int. Cl. G02F 1/1368; G02F 1/1362

(52) U.S. Cl. CPC G02F 1/1368; G02F 1/136295

(57) ABSTRACT

A first substrate of a liquid crystal display device includes a TFT provided in each pixel, a transparent electrode electrically connected to the TFT, a reflective electrode provided on a portion of the transparent electrode which is located in a reflective region, and a terminal portion disposed in a non-display region. The terminal portion includes a lower conductive layer formed in the same layer as a gate electrode of the TFT, an intermediate conductive layer formed of a transparent conductive material and covering the lower conductive layer, and an upper conductive layer formed in the same layer as the transparent electrode, and does not include a conductive layer formed in the same layer as a source electrode and a drain electrode of the TFT.

### CROSS-REFERENCE TO RELATED APPLICATIONS

This application claims the benefit of priority to Japanese Patent Application Number 2024-125655 filed on Aug. 1, 2024. The entire contents of the above-identified application are hereby incorporated by reference.

### BACKGROUND

### Technical Field

The disclosure relates to a liquid crystal display device, and particularly relates to a liquid crystal display device in which each pixel includes a reflective region. Further, the disclosure relates to a manufacturing method for a liquid crystal display device.

In general, liquid crystal display devices are broadly classified into transmissive liquid crystal display devices and reflective liquid crystal display devices. Transmissive liquid crystal display devices perform display in a transmission mode using light emitted from a backlight. Reflective liquid crystal display devices perform display in a reflection mode using ambient light. A liquid crystal display device has been proposed in which each pixel includes a reflective region for display in the reflection mode, and a transmissive region for displaying in the transmission mode. Such a liquid crystal display device is referred to as a transflective or a transmissive/reflective liquid crystal display device.

Reflective and transflective liquid crystal display devices are, for example, suitable for use as medium or small display devices for mobile applications used outside. An example of the reflective liquid crystal display device is disclosed in JP 2000-122094 A. An example of the transflective liquid crystal display device is disclosed in JP 2003-131268 A.

In addition, an active matrix substrate included in a liquid crystal display device includes a terminal portion for connecting a gate wiring line and a source wiring line to an input terminal of a driving circuit in a non-display region. The terminal portion includes a layered structure in which a plurality of conductive layers are layered. Various structures have been proposed as the layered structure of the terminal portion.

### SUMMARY

According to the study made by the inventor of the present application, it has been found that, in reflective and transflective liquid crystal display devices, depending on a layered structure adopted for a terminal portion, a conductive layer configuring the terminal portion may be damaged by an etchant used when forming a reflective electrode.

An embodiment of the disclosure has been made in consideration of the above problems, and an object thereof is to curb damage to a terminal portion caused by an etchant for forming a reflective electrode in a liquid crystal display device in which each pixel includes a reflective region.

The present specification discloses a liquid crystal display device and a manufacturing method for the liquid crystal display device in the following items.

### [Item 1]

A liquid crystal display device including:
a first substrate;
a second substrate facing the first substrate; and
a liquid crystal layer provided between the first substrate and the second substrate, wherein
the liquid crystal display device includes a display region including a plurality of pixels arranged in a matrix including a plurality of rows and a plurality of columns, and a non-display region located around the display region,
each of the plurality of pixels includes a reflective region in which display is performed in a reflection mode,
the first substrate includes a thin film transistor provided in each of the plurality of pixels, a transparent electrode electrically connected to the thin film transistor, a reflective electrode provided on a portion of the transparent electrode, the portion being located in the reflective region, and a terminal portion disposed in the non-display region,
the thin film transistor includes a semiconductor layer including a channel region, and a source region and a drain region located on both sides of the channel region, a gate electrode facing the channel region via a gate insulating layer, a source electrode electrically connected to the source region of the semiconductor layer, and a drain electrode electrically connected to the drain region of the semiconductor layer,
the terminal portion includes a lower conductive layer formed in the same layer as the gate electrode, an intermediate conductive layer formed of a transparent conductive material and covering the lower conductive layer, and an upper conductive layer formed in the same layer as the transparent electrode, and
the terminal portion does not include a conductive layer formed in the same layer as the source electrode and the drain electrode.

### [Item 2]

The liquid crystal display device according to item 1, in which the thin film transistor further includes a protective conductive layer formed in the same layer as the intermediate conductive layer and covering the gate electrode.

### [Item 3]

The liquid crystal display device according to item 1 or 2, in which the first substrate further includes an interlayer insulating layer covering the thin film transistor, and an organic insulating layer provided on the interlayer insulating layer,
the transparent electrode is provided on the organic insulating layer,
a first contact hole exposing a portion of the drain electrode is formed in the interlayer insulating layer and the organic insulating layer, and
the transparent electrode is connected to the drain electrode in the first contact hole.

### [Item 4]

The liquid crystal display device according to item 3, in which the gate electrode is disposed below the semiconductor layer,
a second contact hole exposing a portion of the intermediate conductive layer is formed in the gate insulating layer and the interlayer insulating layer, and
the upper conductive layer is connected to the intermediate conductive layer in the second contact hole.

### [Item 5]

The liquid crystal display device according to item 3 or 4, in which a portion of the organic insulating layer which is located in the reflective region has an uneven surface structure; and
each of the reflective electrode and the portion of the transparent electrode which is located in the reflective region has an uneven surface structure reflecting the uneven surface structure of the organic insulating layer.

### [Item 6]

The liquid crystal display device according to any one of items 1 to 5, in which the first substrate further includes a transparent electrode provided on the reflective electrode.

### [Item 7]

A liquid crystal display device including:
a first substrate;
a second substrate facing the first substrate; and
a liquid crystal layer provided between the first substrate and the second substrate, in which
the liquid crystal display device includes a display region including a plurality of pixels arranged in a matrix including a plurality of rows and a plurality of columns, and a non-display region located around the display region,
each of the plurality of pixels includes a reflective region in which display is performed in a reflection mode,
the first substrate includes a thin film transistor provided in each of the plurality of pixels, a transparent electrode electrically connected to the thin film transistor, a reflective electrode provided on a portion of the transparent electrode, the portion being located in the reflective region, and a terminal portion disposed in the non-display region,
the thin film transistor includes a semiconductor layer including a channel region, and a source region and a drain region located on both sides of the channel region, a gate electrode facing the channel region via a gate insulating layer, a source electrode electrically connected to the source region of the semiconductor layer, and a drain electrode electrically connected to the drain region of the semiconductor layer,
the terminal portion includes a lower conductive layer formed in the same layer as the source electrode and the drain electrode, an intermediate conductive layer formed of a transparent conductive material and covering the lower conductive layer, and an upper conductive layer formed in the same layer as the transparent electrode, and
the terminal portion does not include a conductive layer formed in the same layer as the gate electrode.

### [Item 8]

The liquid crystal display device according to item 7, in which the terminal portion includes a base semiconductor layer formed in the same layer as the semiconductor layer and located below the lower conductive layer.

### [Item 9]

The liquid crystal display device according to item 7 or 8, in which the first substrate further includes an interlayer insulating layer covering the thin film transistor, and an organic insulating layer provided on the interlayer insulating layer,
the transparent electrode is provided on the organic insulating layer,
a first contact hole exposing a portion of the drain electrode is formed in the interlayer insulating layer and the organic insulating layer, and
the transparent electrode is connected to the drain electrode in the first contact hole.

### [Item 10]

The liquid crystal display device according to item 9, in which a second contact hole exposing a portion of the intermediate conductive layer is formed in the interlayer insulating layer, and
the upper conductive layer is connected to the intermediate conductive layer in the second contact hole.

### [Item 11]

The liquid crystal display device according to item 9 or 10, in which a portion of the organic insulating layer which is located in the reflective region has an uneven surface structure, and
each of the reflective electrode and the portion of the transparent electrode which is located in the reflective region has an uneven surface structure reflecting the uneven surface structure of the organic insulating layer. [Item 12]

The liquid crystal display device according to any one of items 7 to 11, in which the first substrate further includes a transparent electrode provided on the reflective electrode.

### [Item 13]

A manufacturing method for the liquid crystal display device according to item 1, in which preparing the first substrate includes
(a) forming the thin film transistor on a substrate,
(b) forming an interlayer insulating layer covering the thin film transistor,
(c) forming an organic insulating layer on the interlayer insulating layer,
(d) forming the transparent electrode on the organic insulating layer, and
(e) forming the reflective electrode on a portion of the transparent electrode, the portion being located in the reflective region, and
(a) forming the thin film transistor includes
(a1) depositing a semiconductor film on the gate insulating layer,
(a2) depositing a source conductive film on the semiconductor film, and
(a3) forming the semiconductor layer, the source electrode, and the drain electrode by patterning the semiconductor film and the source conductive film by a photolithography process using a multi-tone photomask.

### [Item 14]

The manufacturing method according to item 13, in which the organic insulating layer is provided with an opening overlapping a portion of the drain electrode,
a portion of the organic insulating layer which is located in the reflective region has an uneven surface structure, and
(c) forming the organic insulating layer includes
(c1) applying a photosensitive resin material onto the interlayer insulating layer,
(c2) pattern-exposing the photosensitive resin material having been applied, using a multi-tone photomask, and
(c3) developing the photosensitive resin material having been pattern-exposed.

### [Item 15]

The manufacturing method according to item 13 or 14, in which (a) forming the thin film transistor further includes (a4) forming the gate electrode,
the lower conductive layer of the terminal portion is formed together with the gate electrode in (a4) forming the gate electrode, and
the upper conductive layer of the terminal portion is formed together with the transparent electrode in (d) forming the transparent electrode.

### [Item 16]

The manufacturing method according to item 15, in which (a) forming the thin film transistor further includes (a5) forming a protective conductive layer covering the gate electrode, and
the intermediate conductive layer of the terminal portion is formed together with the protective conductive layer in (a5) forming the protective conductive layer.

### [Item 17]

A manufacturing method for the liquid crystal display device according to item 7, in which preparing the first substrate includes
(a) forming the thin film transistor on a substrate,
(b) forming an interlayer insulating layer covering the thin film transistor,
(c) forming an organic insulating layer on the interlayer
(d) forming the transparent electrode on the organic insulating layer, and
(e) forming the reflective electrode on a portion of the transparent electrode, the portion being located in the reflective region, and
(a) forming the thin film transistor includes
(a1) depositing a semiconductor film on the gate insulating layer,
(a2) depositing a source conductive film on the semiconductor film, and
(a3) forming the semiconductor layer, the source electrode, and the drain electrode by patterning the semiconductor film and the source conductive film by a photolithography process using a multi-tone photomask.

### [Item 18]

The manufacturing method according to item 17, in which the organic insulating layer is provided with an opening overlapping a portion of the drain electrode,
a portion of the organic insulating layer which is located in the reflective region has an uneven surface structure, and
(c) forming the organic insulating layer includes
(c1) applying a photosensitive resin material onto the interlayer insulating layer,
(c2) pattern-exposing the photosensitive resin material having been applied, using a multi-tone photomask, and
(c3) developing the photosensitive resin material having been pattern-exposed.

### [Item 19]

The manufacturing method according to item 17 or 18, in which the lower conductive layer of the terminal portion is formed together with the source electrode and the drain electrode in (a3) forming the semiconductor layer, the source electrode, and the drain electrode, and
the upper conductive layer of the terminal portion is formed together with the transparent electrode in (d) forming the transparent electrode.

### [Item 20]

The manufacturing method according to item 19, in which a base semiconductor layer located below the lower conductive layer of the terminal portion is also formed in (a3) forming the semiconductor layer, the source electrode, and the drain electrode.

### [Item 21]

The manufacturing method according to any one of items 17 to 20, further including (f) forming the intermediate conductive layer of the terminal portion after (a) forming the thin film transistor.

According to an embodiment of the disclosure, in a liquid crystal display device in which each pixel includes a reflective region, it is possible to curb damage to a terminal portion caused by an etchant for forming a reflective electrode.

### BRIEF DESCRIPTION OF DRAWINGS

The disclosure will be described with reference to the accompanying drawings, wherein like numbers reference like elements.

FIG. 1 is a schematic plan view illustrating a liquid crystal display device 100 according to an embodiment of the disclosure.

FIG. 2A is a schematic plan view illustrating the liquid crystal display device 100 and illustrates a region corresponding to one pixel P.

FIG. 2B is a schematic cross-sectional view illustrating the liquid crystal display device 100 and illustrates a region corresponding to one pixel P.

FIG. 3A is a schematic plan view illustrating a terminal portion Ta included in a TFT substrate 10 of the liquid crystal display device 100.

FIG. 3B is a schematic cross-sectional view illustrating the terminal portion Ta.

FIG. 4A is a schematic cross-sectional view illustrating a TFT substrate 910 according to a comparative example and illustrates a region corresponding to a pixel P.

FIG. 4B is a schematic cross-sectional view illustrating a terminal portion 910Ta included in the TFT substrate 910 according to the comparative example.

FIG. 5 is a diagram showing the reason why the terminal portion 910Ta of the TFT substrate 910 according to the comparative example is damaged.

FIG. 6A is a process cross-sectional view showing a process of preparing the TFT substrate 10.

FIG. 6B is a process cross-sectional view showing a process of preparing the TFT substrate 10.

FIG. 6C is a process cross-sectional view showing a process of preparing the TFT substrate 10.

FIG. 6D is a process cross-sectional view showing a process of preparing the TFT substrate 10.

FIG. 6E is a process cross-sectional view showing a process of preparing the TFT substrate 10.

FIG. 6F is a process cross-sectional view showing a process of preparing the TFT substrate 10.

FIG. 6G is a process cross-sectional view showing a process of preparing the TFT substrate 10.

FIG. 6H is a process cross-sectional view showing a process of preparing the TFT substrate 10.

FIG. 7A is a process cross-sectional view showing a process of preparing the TFT substrate 10.

FIG. 7B is a process cross-sectional view showing a process of preparing the TFT substrate 10.

FIG. 7C is a process cross-sectional view showing a process of preparing the TFT substrate 10.

FIG. 7D is a process cross-sectional view showing a process of preparing the TFT substrate 10.

FIG. 7E is a process cross-sectional view showing a process of preparing the TFT substrate 10.

FIG. 7F is a process cross-sectional view showing a process of preparing the TFT substrate 10.

FIG. 7G is a process cross-sectional view showing a process of preparing the TFT substrate 10.

FIG. 7H is a process cross-sectional view showing a process of preparing the TFT substrate 10.

FIG. 8A is a schematic cross-sectional view showing another liquid crystal display device 100A according to an embodiment of the disclosure and illustrates a region corresponding to one pixel P.

FIG. 8B is a schematic cross-sectional view showing a terminal portion TaA included in a TFT substrate 10 of the liquid crystal display device 100A.

FIG. 9A is a process cross-sectional view showing a process of manufacturing the TFT substrate 10 of the liquid crystal display device 100A.

FIG. 9B is a process cross-sectional view showing a process of preparing the TFT substrate 10 of the liquid crystal display device 100A.

FIG. 9C is a process cross-sectional view showing a process of preparing the TFT substrate 10 of the liquid crystal display device 100A.

FIG. 9D is a process cross-sectional view showing a process of preparing the TFT substrate 10 of the liquid crystal display device 100A.

FIG. 9E is a process cross-sectional view showing a process of preparing the TFT substrate 10 of the liquid crystal display device 100A.

FIG. 9F is a process cross-sectional view showing a process of preparing the TFT substrate 10 of the liquid crystal display device 100A.

FIG. 9G is a process cross-sectional view showing a process of preparing the TFT substrate 10 of the liquid crystal display device 100A.

FIG. 9H is a process cross-sectional view showing a process of preparing the TFT substrate 10 of the liquid crystal display device 100A.

FIG. 10A is a process cross-sectional view showing a process of preparing the TFT substrate 10 of the liquid crystal display device 100A.

FIG. 10B is a process cross-sectional view showing a process of preparing the TFT substrate 10 of the liquid crystal display device 100A.

FIG. 10C is a process cross-sectional view showing a process of preparing the TFT substrate 10 of the liquid crystal display device 100A.

FIG. 10D is a process cross-sectional view showing a process of preparing the TFT substrate 10 of the liquid crystal display device 100A.

FIG. 10E is a process cross-sectional view showing a process of preparing the TFT substrate 10 of the liquid crystal display device 100A.

FIG. 10F is a process cross-sectional view showing a process of preparing the TFT substrate 10 of the liquid crystal display device 100A.

FIG. 10G is a process cross-sectional view showing a process of preparing the TFT substrate 10 of the liquid crystal display device 100A.

FIG. 10H is a process cross-sectional view showing a process of preparing the TFT substrate 10 of the liquid crystal display device 100A.

### DESCRIPTION OF EMBODIMENTS

Hereinafter, embodiments of the disclosure will be described with reference to the accompanying drawings. In the following, a reflective liquid crystal display device is illustrated as an embodiment of the disclosure.

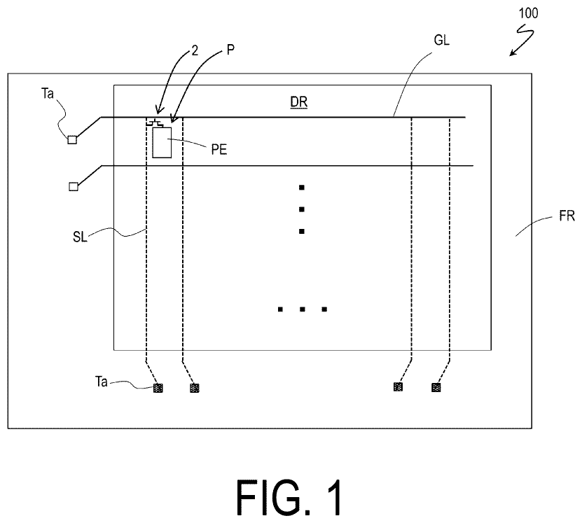

A liquid crystal display device 100 according to an embodiment of the disclosure will be described with reference to FIG. 1. FIG. 1 is a schematic plan view illustrating the liquid crystal display device 100.

The liquid crystal display device 100, as illustrated in FIG. 1, includes a display region DR and a non-display region (peripheral region) FR positioned around the display region DR. The display region DR includes a plurality of pixels P. The plurality of pixels P are arrayed in a matrix shape including a plurality of rows and a plurality of columns. Each of the pixels P is provided with a thin film transistor (TFT) 2, and a pixel electrode PE.

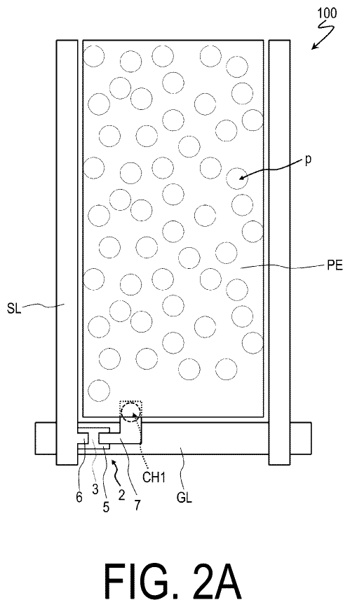

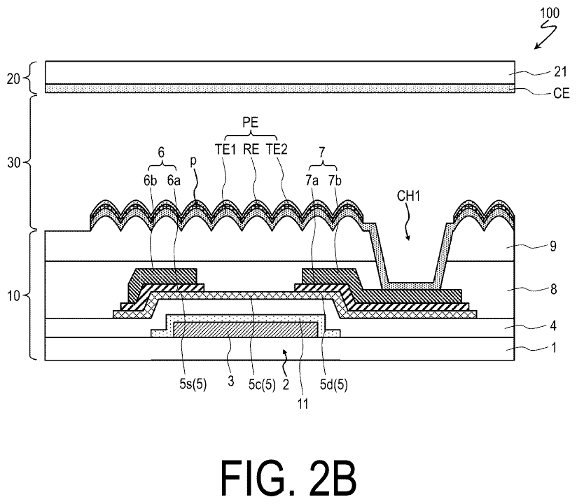

Here, the liquid crystal display device 100 will be described more specifically with reference to FIG. 2A and FIG. 2B. FIGS. 2A and 2B are a plan view and a cross-sectional view schematically illustrating the liquid crystal display device 100 and illustrate a region corresponding to one pixel P.

As illustrated in FIG. 2B, the liquid crystal display device 100 includes an active matrix substrate (hereinafter, referred to as a “TFT substrate”) 10, a counter substrate (also referred to as a “color filter substrate”) 20 facing the TFT substrate 10, and a liquid crystal layer 30 provided between the TFT substrate 10 and the counter substrate 20. Each pixel P of the liquid crystal display device 100 includes a reflective region in which display is performed in a reflection mode using ambient light. Since the liquid crystal display device 100 of the present embodiment is a reflective type, the entire region of the pixel P which contributes to display is a reflective region.

As illustrated in FIG. 1 and FIG. 2A, the TFT substrate 10 includes a plurality of gate wiring lines (scanning wiring lines) GL extending in a row direction, a plurality of source wiring lines (signal wiring lines) SL extending in a column direction, the TFT 2 provided in each of the pixels P, and the pixel electrode PE electrically connected to the TFT 2. The gate wiring lines GL and the like described above are supported by a substrate 1 having insulating properties. The substrate 1 is, for example, a glass substrate.

The TFT 2 includes a gate electrode 3, a gate insulating layer 4, a semiconductor layer 5, a source electrode 6, and a drain electrode 7. The semiconductor layer 5 includes a channel region 5c, and a source region 5s and a drain region 5d respectively located on both sides of the channel region 5c. The semiconductor layer 5 is an amorphous silicon layer here, but the material of the semiconductor layer 5 is not limited to amorphous silicon. Although not illustrated in the drawing, the semiconductor layer 5 includes an intrinsic semiconductor layer and an impurity-doped semiconductor layer whose resistance is reduced by doping with impurities. The impurity-doped semiconductor layer is provided on the intrinsic semiconductor layer. The impurity-doped semiconductor layer is formed in the source region 5s and the drain region 5d, but not in the channel region 5c. The intrinsic semiconductor layer is formed in the channel region 5c, the source region 5s, and the drain region 5d.

The gate electrode 3 is disposed below the semiconductor layer 5 (that is, between the semiconductor layer 5 and the substrate 1), and face the channel regions 5c of the semiconductor layer 5 via the gate insulating layer 4. The gate electrode 3 is electrically connected to the corresponding gate wiring line GL and supplied with a gate signal (scanning signal) from the gate wiring line GL. In the example illustrated in the drawing, the gate electrode 3 is formed integrally with the gate wiring line GL. More specifically, a region of the gate wiring line GL that overlaps the semiconductor layer 5 in a plan view functions as the gate electrode 3.

In the example illustrated in the drawing, the TFT 2 further includes a conductive layer 11 that covers the gate electrodes 3. Hereinafter, the conductive layer 11 will be referred to as a “protective conductive layer”. The protective conductive layer 11 is formed of a transparent conductive material.

The gate insulating layer 4 is formed to cover the gate electrode 3 and the protective conductive layer 11. The semiconductor layer 5 is provided on the gate insulating layer 4.

The source electrode 6 is provided on the semiconductor layer 5. The source electrode 6 is in contact with the source region 5s of the semiconductor layer 5 and is electrically connected to the source region 5s. In addition, the source electrode 6 is electrically connected to the corresponding source wiring line SL and supplied with a source signal (display signal) from the source wiring line SL. In the example illustrated in the drawing, the source electrode 6 is formed integrally with the source wiring line SL. More specifically, the source electrode 6 is extended from the source wiring line SL.

The drain electrode 7 is provided on the semiconductor layer 5 and the gate insulating layer 4. The drain electrode 7 is in contact with the drain region 5d of the semiconductor layer 5 and is electrically connected to the drain region 5d. The drain electrode 7 is also electrically connected to the pixel electrode PE. The drain electrode 7 is formed in the same layer as the source wiring line SL and the source electrode 6 (that is, formed of the same conductive film).

In the example illustrated in the drawing, the source electrode 6 includes a layered structure including a lower layer 6a and an upper layer 6b formed on the lower layer 6a, and similarly, the drain electrode 7 includes a layered structure including a lower layer 7a and an upper layer 7b formed on the lower layer 7a. The lower layers 6a and 7a of the source electrode 6 and the drain electrode 7 are, for example, Ti layers, and the upper layers 6b and 7b of the source electrode 6 and the drain electrode 7 are, for example, Cu layers, but of course, are not limited thereto. Further, the source electrode 6 and the drain electrode 7 may not include a layered structure.

An interlayer insulating layer (passivation layer) 8 is provided to cover the TFT 2. The interlayer insulating layer 8 is, for example, an inorganic insulating layer.

An organic insulating layer (flattening layer) 9 is provided on the interlayer insulating layer 8. The surface of the organic insulating layer 9 includes an uneven shape in part (specifically, a part located in the reflective region). That is, the part of the organic insulating layer 9 located in the reflective region has an uneven surface structure. The organic insulating layer 9 having the uneven surface structure may be formed by using a photosensitive resin material, as described in, for example, JP 3394926 B.

As illustrated in FIG. 2B, the pixel electrode PE includes a first transparent electrode TE1, a reflective electrode RE, and a second transparent electrode TE2.

The first transparent electrode TEL is provided on the organic insulating layer 9. The first transparent electrode TE1 is formed of a transparent conductive material (for example, ITO). The first transparent electrode TEL is electrically connected to the TFT2. In the example illustrated in the drawing, a first contact hole CH1 exposing a portion of the drain electrode 7 is formed in the interlayer insulating layer 8 and the organic insulating layer 9, and the first transparent electrode TE1 is connected to the drain electrode 7 at this first contact hole CH1.

The reflective electrode RE is provided on a portion of the first transparent electrode TRI located in the reflective region, and is not provided on a portion of the first transparent electrode TRI which is located in the first contact hole CH1. The reflective electrode RE is formed of a metal material with high reflectivity (for example, aluminum or silver). The reflective electrode RE is in contact with the first transparent electrode TE1 and is electrically connected to the drain electrode 7 of the TFT 2 via the first transparent electrode TE1.

The second transparent electrode TE2 is provided on the reflective electrode RE. The second transparent electrode TE2 is formed of a transparent conductive material (for example, ITO). The second transparent electrode TE2 is in contact with the reflective electrode RE, and is electrically connected to the drain electrode 7 of the TFT 2 via the reflective electrode RE and the first transparent electrode TE1.

The portion of the first transparent electrode TE1 located in the reflective region, the reflective electrode RE, and the second transparent electrode TE2 each include an uneven surface structure reflecting the uneven surface structure of the organic insulating layer 9. Since the reflective electrode RE has an uneven surface structure, it is possible to diffusely reflect ambient light and implement display that is close to paper white. The uneven surface structure can, for example, be configured with a plurality of protruding portions p disposed randomly such that a center-to-center spacing between adjacent protruding portions p is 5 μm or more and 50 μm or less, and preferably 10 μm or more and 20 μm or less. When viewed from a normal direction of the substrate 1, shapes of the protruding portions p are substantially circular or substantially polygonal. An area of the protruding portions p occupying the pixel P is, for example, from approximately 20% to 40%. A height of the protruding portion p is, for example, 1 μm or more and 5 μm or less.

The counter substrate 20 includes a counter electrode (common electrode) CE. The counter electrode CE is formed of a transparent conductive material (for example, ITO). The counter electrode CE faces the pixel electrode PE. A voltage common to the plurality of pixels P (common voltage) is applied to the counter electrode CE.

Although not illustrated in the drawing here, the counter substrate 20 typically further includes a light-blocking layer (black matrix) and a color filter layer. The light-blocking layer is formed in a substantially lattice shape. The color filter layer typically includes a red color filter, a green color filter, and a blue color filter.

The above-mentioned counter electrode CE and the like are supported by a transparent and insulating substrate 21. The substrate 21 is, for example, a glass substrate.

A pair of alignment films (not illustrated) is provided on outermost surfaces of the TFT substrate 10 and the counter substrate 20 on the liquid crystal layer 30 side. As the pair of alignment films, a horizontal alignment film or a vertical alignment film may be used in accordance with a display mode.

The thickness of the liquid crystal layer 30 can be specified by a plurality of columnar spacers (not illustrated). The columnar spacer is formed of a photosensitive resin material.

As illustrated in FIG. 1, the TFT substrate 10 further includes a plurality of terminal portions Ta disposed in a non-display region FR. Each gate wiring line GL is connected to a gate driver (not illustrated) via a corresponding terminal portion Ta, and each source wiring line SL is connected to a source driver (not illustrated) via a corresponding terminal portion Ta.

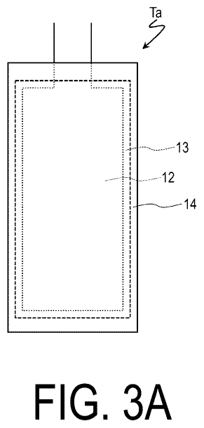

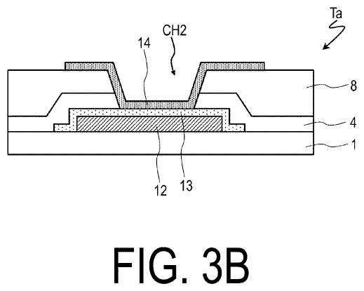

The structure of the terminal portion Ta will be described with reference to FIGS. 3A and 3B. FIGS. 3A and 3B are a plan view and a cross-sectional view that schematically illustrate the terminal portion Ta.

As illustrated in FIGS. 3A and 3B, the terminal portion Ta includes a lower conductive layer (first conductive layer) 12, an intermediate conductive layer (second conductive layer) 13, and an upper conductive layer (third conductive layer) 14. The lower conductive layer 12, the intermediate conductive layer 13, and the upper conductive layer 14 are layered in this order from the substrate 1 side.

The lower conductive layer 12 is formed in the same layer as the gate electrode 3 (that is, formed of the same conductive film as the gate electrode 3). The intermediate conductive layer 13 covers the lower conductive layer 12, and is formed in the same layer as the protective conductive layer 11 (that is, formed of the same conductive film as the protective conductive layer 11). Thus, the intermediate conductive layer 13 is formed of a transparent conductive material.

The upper conductive layer 14 is formed in the same layer as the first transparent electrode TEL (that is, formed of the same conductive film as the first transparent electrode TE1). A second contact hole CH2 exposing a portion of the intermediate conductive layer 13 is formed in the gate insulating layer 4 and the interlayer insulating layer 8, and the upper conductive layer 14 is connected to the intermediate conductive layer 13 at a second contact hole CH2. Accordingly, the lower conductive layer 12, the intermediate conductive layer 13, and the upper conductive layer 14 are electrically connected to each other.

Furthermore, the terminal portion Ta does not include a conductive layer formed in the same layer as the source electrode 6 and the drain electrode 7. That is, the terminal portion Ta does not include a conductive layer formed of the same conductive film as the source electrode 6 and the drain electrode 7.

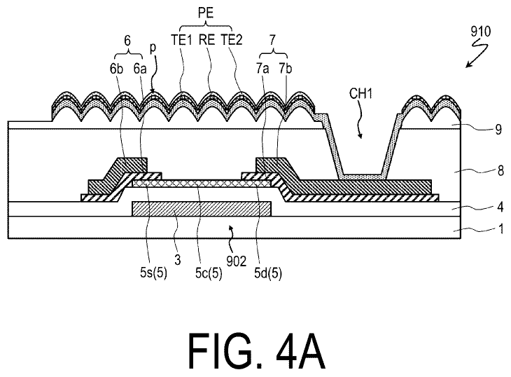

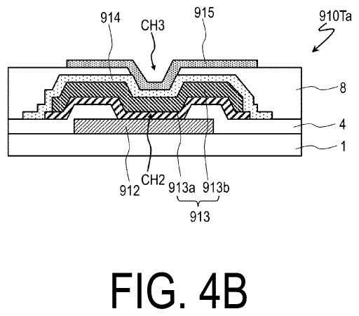

Since the liquid crystal display device 100 according to the embodiment of the disclosure includes the above-described structure, it is possible to curb damage to the terminal portion Ta caused by an etchant used when the reflective electrode RE is formed. The reason for this will be described below with reference to the structure of a TFT substrate 910 according to a comparative example illustrated in FIGS. 4A and 4B.

FIG. 4A is a schematic cross-sectional view illustrating the TFT substrate 910 according to the comparative example, and illustrates a region corresponding to a pixel P. FIG. 4B is a schematic cross-sectional view illustrating a terminal portion 910Ta included in the TFT substrate 910 according to the comparative example.

As illustrated in FIG. 4A, the TFT substrate 910 according to the comparative example is different from the TFT substrate 10 of the liquid crystal display device 100 in that a TFT 902 does not include a protective conductive layer covering the gate electrode 3. As illustrated in FIG. 4B, in the TFT substrate 910 according to the comparative example, the structure of the terminal portion 910Ta is also different from that of the terminal portion Ta of the TFT substrate 10 of the liquid crystal display device 100.

The terminal portion 910Ta of the TFT substrate 910 according to the comparative example includes a first conductive layer 912, a second conductive layer 913, a third conductive layer 914, and a fourth conductive layer 915. The first conductive layer 912, the second conductive layer 913, the third conductive layer 914, and the fourth conductive layer 915 are layered in this order from the substrate 1 side.

The first conductive layer 912 is formed in the same layer as the gate electrode 3. The second conductive layer 913 is formed in the same layer as the source electrode 6 and the drain electrode 7. For this reason, the second conductive layer 913 includes a layered structure including a lower layer 913a and an upper layer 913b formed on the lower layer 913a. A second contact hole CH2 exposing a portion of the first conductive layer 912 is formed in the gate insulating layer 4, and the second conductive layer 913 is connected to the first conductive layer 912 in the second contact hole CH2.

The third conductive layer 914 covers the second conductive layer 913 and is formed of a transparent conductive material. The fourth conductive layer 915 is formed in the same layer as the first transparent electrode TE1. A third contact hole CH3 exposing a portion of the third conductive layer 914 is formed in the interlayer insulating layer 8, and the fourth conductive layer 915 is connected to the third conductive layer 914 at the third contact hole CH3. The first conductive layer 912, the second conductive layer 913, the third conductive layer 914, and the fourth conductive layer 915 are electrically connected to each other.

In the TFT substrate 910 according to the comparative example having the above-described structure, the terminal portion 910Ta may be damaged by an etchant (for example, a PAN-based etchant containing phosphoric acid, nitric acid, and acetic acid) used when forming the reflective electrode RE. It is presumed that the damage to the terminal portion 910Ta is caused by the following reasons.

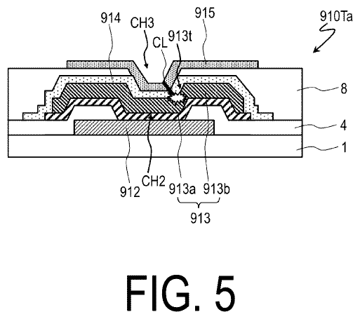

In the terminal portion 910Ta of the TFT substrate 910 according to the comparative example, as illustrated in FIG. 5, the second conductive layer 913 includes a steep tapered portion 913t reflecting the shape of the second contact hole CH2. For this reason, cracks CL occur in portions of the third conductive layer 914 and the fourth conductive layer 915, which are formed of a transparent conductive material, located on the tapered portion 913t, and an upper layer 913b (for example, a Cu layer) of the second conductive layer 913 is damaged by an etchant entering through the cracks CL.

On the other hand, in the liquid crystal display device 100 of the present embodiment, the lower conductive layer 12 which may be formed of a metal material is covered with the intermediate conductive layer 13 formed of a transparent conductive material. Since cracks are less likely to occur in the intermediate conductive layer 13 that does not include a portion located on the steep tapered portion, the lower conductive layer 12 is protected by the intermediate conductive layer 13 from the etchant used when forming the reflective electrode RE. For this reason, damage to the terminal portion Ta is curbed.

In the illustrated configuration, the first transparent electrode TE1 is disposed below the reflective electrode RE, and the second transparent electrode TE2 is disposed above the reflective electrode RE. Since the first transparent electrodes TE1 is disposed below the reflective electrode RE, the adhesion of the reflective electrode RE to the organic insulating layer 9 can be improved. In addition, since the second transparent electrode TE2 is disposed on the reflective electrode RE, it is possible to curb oxidation of the reflective electrode RE and to prevent deterioration of display characteristics caused by oxidation of the reflective electrode RE.

### Manufacturing Method for Liquid Crystal Display Device 100

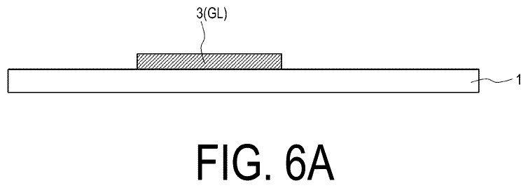

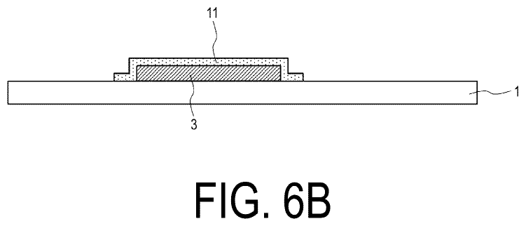

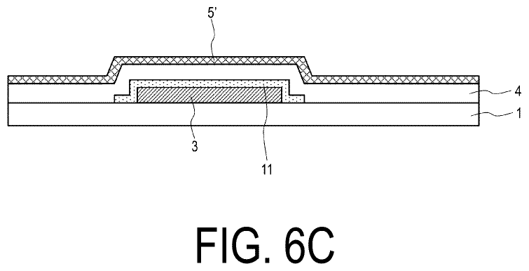

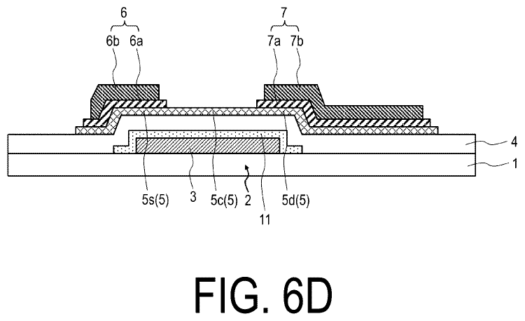

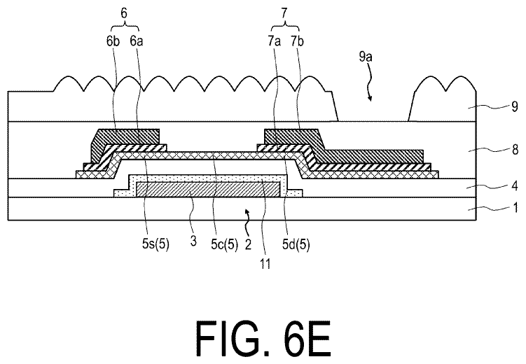

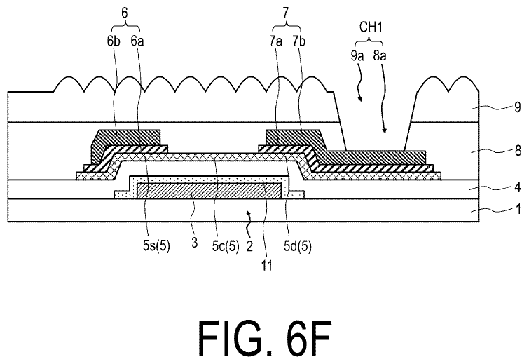

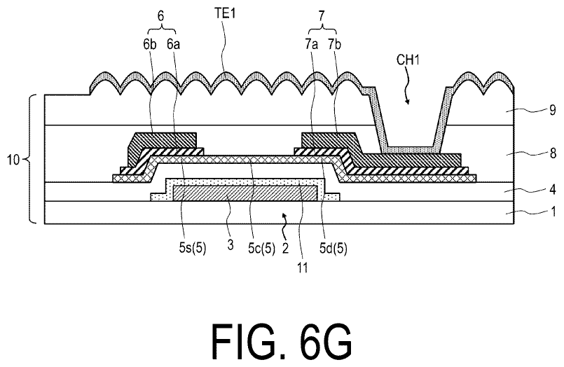

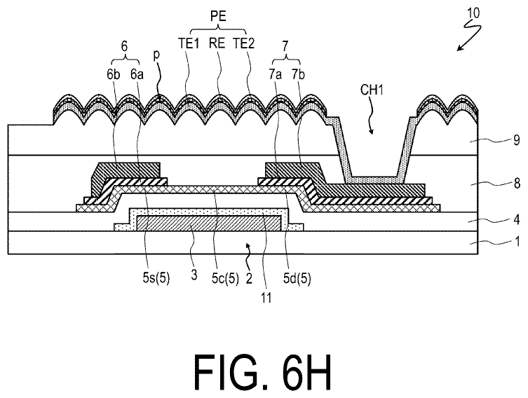

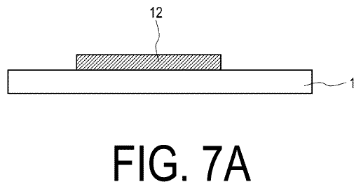

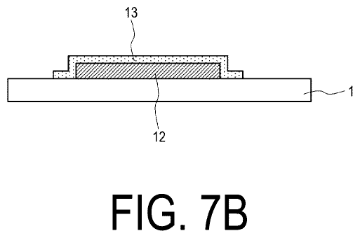

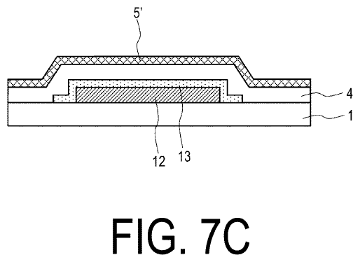

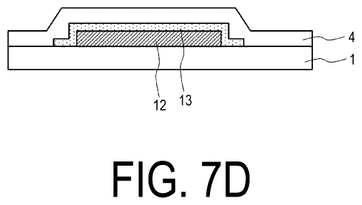

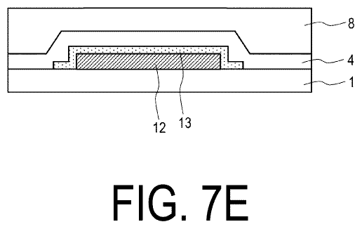

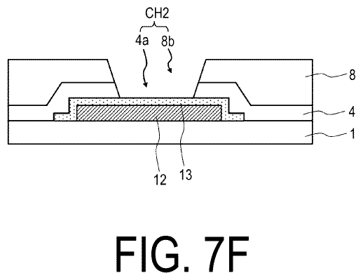

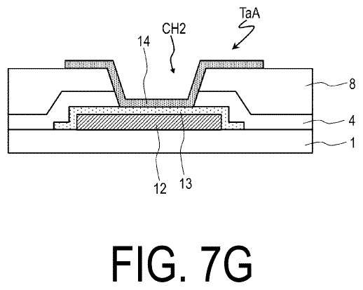

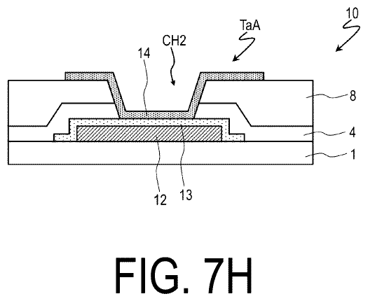

A manufacturing method for the liquid crystal display device 100 will now be described. First, a process of preparing the TFT substrate 10 will be described with reference to FIGS. 6A to 6H and FIGS. 7A to 7H.

FIGS. 6A to 6H and FIGS. 7A to 7H are process cross-sectional views illustrating a process of preparing the TFT substrate 10. FIGS. 6A to 6H illustrate a region where the TFT 2 is formed (TFT formation region), and FIGS. 7A to 7H illustrate a region where the terminal portion Ta is formed (terminal portion formation region).

### Step 1: Formation of Gate Metal Layer (FIGS. 6A and 7A)

First, a gate conductive film (thickness: for example, 50 nm or more and 600 nm or less) is deposited on the substrate 1. The gate conductive film is deposited by, for example, a sputtering method. Next, the gate conductive film is patterned by a photolithography process. As a result, as illustrated in FIGS. 6A and 7A, the gate electrode 3, the gate wiring line GL, and the lower conductive layer (first conductive layer) 12 are formed. The gate electrode 3, the gate wiring line GL, and the lower conductive layer 12 may be collectively referred to as a “gate metal layer”.

As the substrate 1, a substrate having insulating properties can be used. Specifically, as the substrate 1, a glass substrate, a silicon substrate, a plastic substrate (resin substrate) having heat resistance, or the like can be used.

As the gate conductive film, for example, a metal film including an element selected from aluminum (Al), chromium (Cr), copper (Cu), tantalum (Ta), titanium (Ti), molybdenum (Mo), or tungsten (W), or an alloy film including these elements as components can be used. In addition, a layered film including a plurality of films among these films may be used.

### Step 2: Formation of Protective Conductive Layer 11 and the Like (FIGS. 6B and 7B)

Next, a transparent conductive film (thickness: for example, 20 nm or more and 300 nm or less) is formed to cover the gate metal layer. The transparent conductive film is formed by, for example, a sputtering method. As the material of the transparent conductive film, for example, ITO can be used. The transparent conductive film is then patterned by a photolithography process. As a result, the protective conductive layer 11 and the intermediate conductive layer 13 are formed as illustrated in FIGS. 6B and 7B.

### Step 3: Formation of Gate Insulating Layer 4 and Deposition of Semiconductor Film 5′ (FIGS. 6C and 7C)

Next, as illustrated in FIGS. 6C and 7C, a gate insulating layer 4 (thickness: for example, 200 nm and more and 600 nm or less) is formed to cover the protective conductive layer 11 and the intermediate conductive layer 13, and a semiconductor film 5′ is then deposited on the gate insulating layer 4.

The gate insulating layer 4 is formed by, for example, a CVD method. As the gate insulating layer 4, for example, a silicon nitride (SiNx) layer can be used.

The semiconductor film 5′ is an amorphous silicon film here and is deposited by, for example, a CVD method. The thickness of the intrinsic semiconductor layer is, for example, 50 nm or more and 200 nm or less, and the thickness of the impurity-doped semiconductor layer is, for example, approximately 40 nm.

### Step 4: Formation of Source Metal Layer, Patterning of Semiconductor Film 5′ (FIGS. 6D and 7D)

Next, a source conductive film (thickness: for example, 50 nm or more and 500 nm or less) is deposited on the semiconductor film 5′. The source conductive film is deposited by, for example, a sputtering method. Next, the semiconductor film 5′ and the source conductive film are patterned by a photolithography process using a multi-tone photomask. As a result, as illustrated in FIGS. 6D and 7D, the semiconductor layer 5 having an island shape, the source electrode 6, the drain electrode 7, and the source wiring line SL are formed. The source electrode 6, the drain electrode 7, and the source wiring line SL are collectively referred to as a “source metal layer”.

To be specific, a gray tone mask or a halftone mask can be used as the multi-tone photomask. Slits that are smaller than or equal to the resolution of an exposure system are formed in the gray tone mask, and intermediate exposure is achieved by blocking part of the light with these slits. On the other hand, intermediate exposure is achieved by using a transflective film in the halftone mask.

As the source conductive film, for example, a metal film including an element selected from aluminum (Al), chromium (Cr), copper (Cu), tantalum (Ta), titanium (Ti), molybdenum (Mo), or tungsten (W), or an alloy film including these elements as components can be used. In addition, a layered film including a plurality of films among these films may be used. Here, a source conductive film including a Ti film as a lower layer and including a Cu film as an upper layer is formed. In this manner, the TFT 2 is completed.

### Step 5: Formation of Interlayer Insulating Layer 8 and Organic Insulating Layer 9 (FIGS. 6E and 7E)

Next, as illustrated in FIGS. 6E and 7E, the interlayer insulating layer 8 (thickness: for example, 100 nm or more and 500 nm or less) is formed to cover the TFT 2, and then the organic insulating layer 9 (thickness: for example, 1 to 3 μm) is formed on the interlayer insulating layer 8.

The interlayer insulating layer 8 is formed by, for example, a CVD method. As the interlayer insulating layer 8, a silicon oxide (SiOx) layer, a silicon nitride (SiNx) layer, or the like can be used as appropriate. The interlayer insulating layer 8 may be a single layer, or may include a layered structure.

The organic insulating layer 9 may be formed of, for example, a photosensitive resin material. As the photosensitive resin material, for example, an acrylic resin material can be used.

An uneven surface structure is formed on the surface of a portion of the organic insulating layer 9 which is located in the reflective region. In addition, an opening 9a is formed in the organic insulating layer 9 so as to overlap a portion of the drain electrode 7 when viewed from the normal direction of the substrate 1. Furthermore, the organic insulating layer 9 is not formed in the terminal portion formation region.

A process of forming the organic insulating layer 9 includes, for example, a process of applying a photosensitive resin material onto the interlayer insulating layer 8, a process of pattern-exposing the applied photosensitive resin material with the use of a multi-tone photomask, a process of developing the pattern-exposed photosensitive resin material, and a process of performing baking after development.

### Step 6: Formation of Openings 4a, 8a, and 8b in Gate Insulating Layer 4 and Interlayer Insulating Layer 8 (FIGS. 6F and 7F)

Next, as illustrated in FIGS. 6F and 7F, openings 4a, 8a, and 8b are formed in the gate insulating layer 4 and the interlayer insulating layer 8 by a photolithography process. Specifically, the opening 8a is formed in the interlayer insulating layer 8 to expose a portion of the drain electrode 7 in the TFT formation region, and the openings 4a and 8b are formed in the gate insulating layer 4 and the interlayer insulating layer 8 to expose a portion of the intermediate conductive layer 13 in the terminal portion formation region.

### Step 7: Formation of First Transparent Electrode TEL and the Like (FIGS. 6G and 7G)

Thereafter, a transparent conductive film (thickness: for example, 20 nm or more and 300 nm or less) is formed on the organic insulating layer 9. The transparent conductive film is formed by, for example, a sputtering method. As the material of the transparent conductive film, for example, ITO can be used. Next, the transparent conductive film is patterned by a photolithography process. As a result, the first transparent electrode TE1 and the upper conductive layer 14 are formed on the organic insulating layer 9 as illustrated in FIGS. 6G and 7G.

### Step 8: Formation of Reflective Electrode RE and Second Transparent Electrode TE2 (FIGS. 6H and 7H)

Next, a conductive film (thickness: for example, 50 nm or more and 300 nm or less) and a transparent conductive film (thickness: for example, 20 nm or more and 300 nm or less) are successively formed on the first transparent electrode TEL and the organic insulating layer 9. The conductive film and the transparent conductive film are formed by, for example, a sputtering method. Next, the conductive film and transparent conductive film are patterned by a photolithography process. As a result, as illustrated in FIG. 6H, the reflective electrode RE and the second transparent electrode TE2 are formed on a portion of the first transparent electrode TEL which is located in the reflective region. The conductive film for forming the reflective electrode RE is, for example, an Al film, an Al alloy film, an Ag film, or an Ag alloy film. As the material of the transparent conductive film for forming the second transparent electrode TE2, for example, ITO can be used.

In this manner, the TFT substrate 10 is prepared. The process of preparing the counter substrate 20 and the process of forming the liquid crystal layer 30 may be performed using various known techniques, and thus, descriptions thereof will be omitted herein.

According to the above-described manufacturing method, the semiconductor film 5′ and the source conductive film are simultaneously patterned by a photolithography process using a multi-tone photomask, and thus, the number of masks can be reduced. Further, in the process of forming the organic insulating layer 9, pattern exposure using a multi-tone photomask is performed, whereby the number of masks can also be reduced. In the illustrated manufacturing method, the TFT substrate 10 can be manufactured using eight photomasks.

### Another Liquid Crystal Display Device 100A

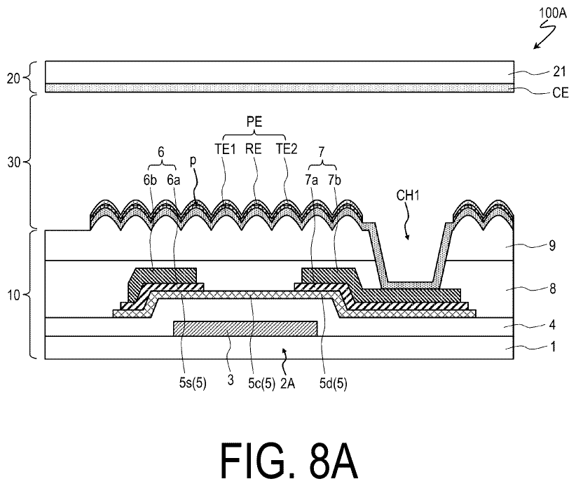

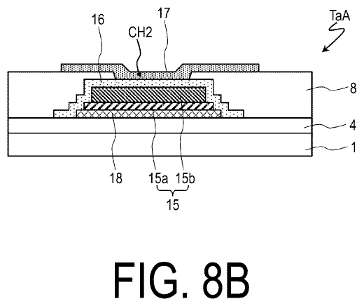

Another liquid crystal display device 100A according to an embodiment of the disclosure will be described with reference to FIGS. 8A and 8B. FIG. 8A is a schematic cross-sectional view illustrating the liquid crystal display device 100A and illustrates a region corresponding to one pixel P. FIG. 8B is a schematic cross-sectional view illustrating a terminal portion TaA included in the TFT substrate 10 of the liquid crystal display device 100A. The following description will focus on differences between the liquid crystal display device 100A and the liquid crystal display device 100 already described.

The structure of each pixel P of the liquid crystal display device 100A is substantially the same as the structure of each pixel P of the liquid crystal display device 100. However, as illustrated in FIG. 8A, a TFT 2A included in the TFT substrate 10 of the liquid crystal display device 100A does not include a protective conductive layer that covers the gate electrodes 3.

The TFT substrate 10 of the liquid crystal display device 100A includes a plurality of terminal portions TaA disposed in a non-display region FR. As illustrated in FIG. 8B, each terminal portion TaA includes a lower conductive layer (first conductive layer) 15, an intermediate conductive layer (second conductive layer) 16, and an upper conductive layer (third conductive layer) 17.

The lower conductive layer 15 is formed in the same layer as the source electrode 6 and the drain electrode 7 (that is, formed of the same conductive film as the source electrode 6 and the drain electrode 7). In the example illustrated in the drawing, the lower conductive layer 15 includes a layered structure including a lower layer 15a and an upper layer 15b formed on the lower layer 15a. The intermediate conductive layer 16 is formed of a transparent conductive material and covers the lower conductive layer 15.

The upper conductive layer 17 is formed in the same layer as the first transparent electrode TEL (that is, formed of the same conductive film as the first transparent electrode TE1). A second contact hole CH2 exposing a portion of the intermediate conductive layer 16 is formed in the interlayer insulating layer 8, and the upper conductive layer 17 is connected to the intermediate conductive layer 16 in the second contact hole CH2. Accordingly, the lower conductive layer 15, the intermediate conductive layer 16, and the upper conductive layer 17 are electrically connected to each other.

In addition, the terminal portion TaA further includes a base semiconductor layer 18 located below the lower conductive layer 15. The base semiconductor layer 18 is formed in the same layer as the semiconductor layer 5 (that is, formed of the same semiconductor film as the semiconductor layer 5).

The terminal portion TaA does not include a conductive layer formed in the same layer as the gate electrode 3. That is, the terminal portion TaA does not include a conductive layer formed of the same conductive film as the gate electrode 3.

In the liquid crystal display device 100A having the above-described structure, the lower conductive layer 15 which may be formed of a metal material is covered with the intermediate conductive layer 16 formed of a transparent conductive material. Since cracks are less likely to occur in the intermediate conductive layer 16 that does not include a portion located on the steep tapered portion, the lower conductive layer 15 is protected by the intermediate conductive layer 16 from the etchant used when forming the reflective electrode RE. For this reason, also in the liquid crystal display device 100A, damage to the terminal portion TaA is curbed.

### Manufacturing Method for Liquid Crystal Display Device 100A

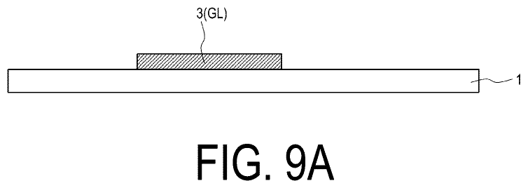

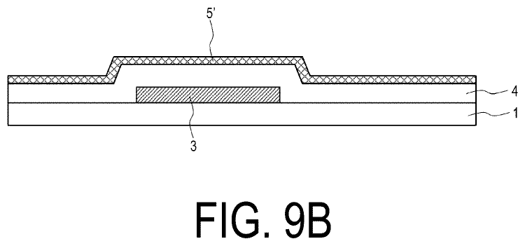

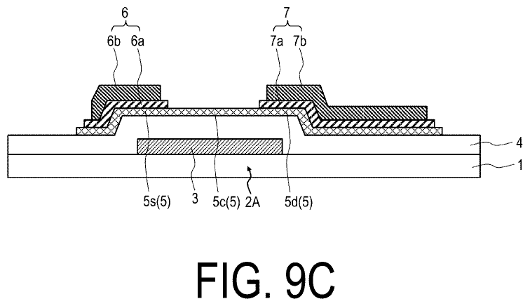

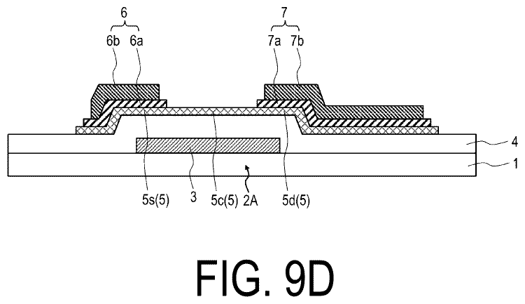

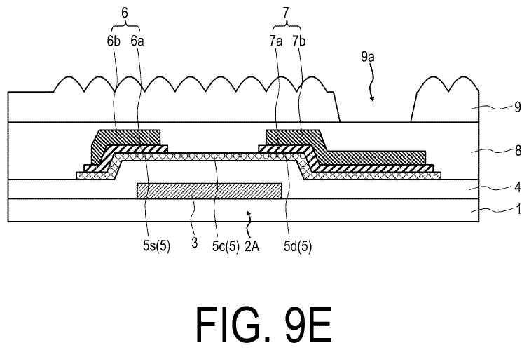

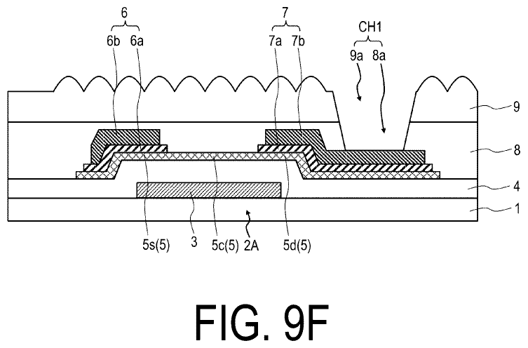

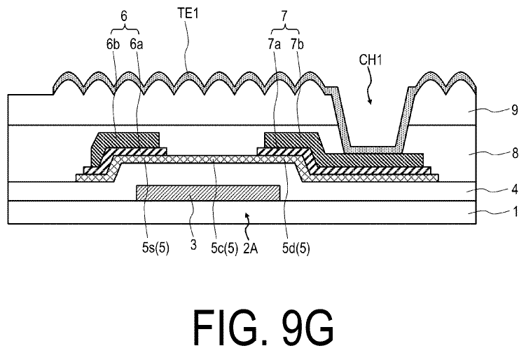

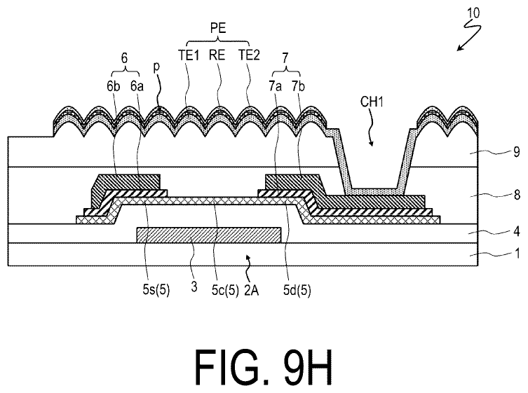

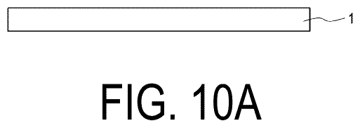

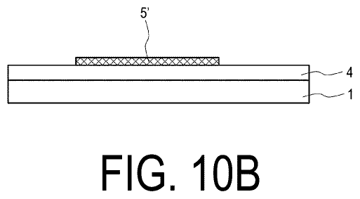

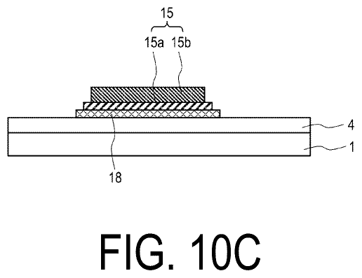

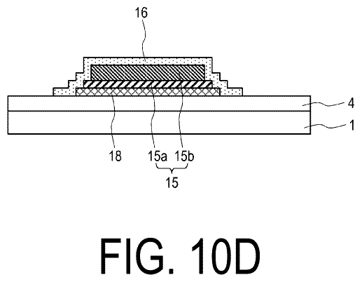

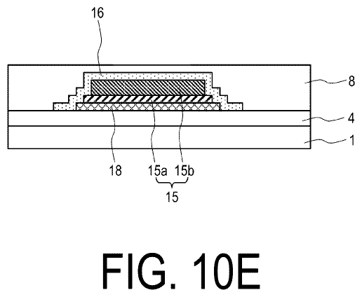

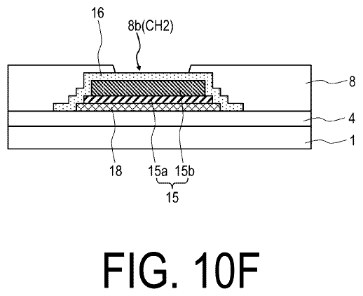

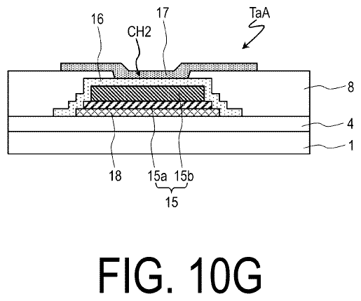

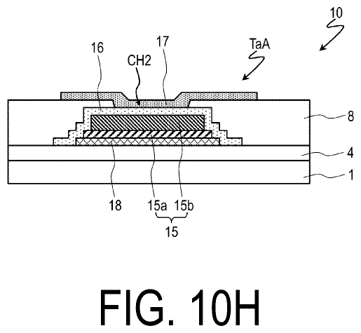

A manufacturing method for the liquid crystal display device 100A will now be described. First, a process of preparing the TFT substrate 10 will be described with reference to FIGS. 9A to 9H and FIGS. 10A to 10H.

FIGS. 9A to 9H and FIGS. 10A to 10H are process cross-sectional views illustrating a process of preparing the TFT substrate 10 of the liquid crystal display device 100A. FIGS. 9A to 9H illustrate a region where the TFT 2A is formed (TFT formation region), and FIGS. 10A to 10H illustrate a region where the terminal portion TaA is formed (terminal portion formation region).

### Step 1: Formation of Gate Metal Layer (FIGS. 9A and 10A)

First, a gate conductive film (thickness: for example, 50 nm or more and 600 nm or less) is deposited on the substrate 1. The gate conductive film is deposited by, for example, a sputtering method. Next, the gate conductive film is patterned by a photolithography process. As a result, as illustrated in FIG. 9A, the gate electrode 3 and the gate wiring line GL are formed. The gate electrode 3 and the gate wiring line GL are collectively referred to as a “gate metal layer”.

As the substrate 1, a substrate having insulating properties can be used. Specifically, as the substrate 1, a glass substrate, a silicon substrate, a plastic substrate (resin substrate) having heat resistance, or the like can be used.

As the gate conductive film, for example, a metal film including an element selected from aluminum (Al), chromium (Cr), copper (Cu), tantalum (Ta), titanium (Ti), molybdenum (Mo), or tungsten (W), or an alloy film including these elements as components can be used. In addition, a layered film including a plurality of films among these films may be used.

### Step 2: Formation of Gate Insulating Layer 4 and Deposition of Semiconductor Film 5′ (FIGS. 9B and 10B)

Next, as illustrated in FIGS. 9B and 10B, the gate insulating layer 4 (thickness: for example, 200 nm or more and 600 nm or less) is formed to cover the gate metal layer, and then the semiconductor film 5′ is deposited on the gate insulating layer 4.

The gate insulating layer 4 is formed by, for example, a CVD method. As the gate insulating layer 4, for example, a silicon nitride (SiNx) layer can be used.

The semiconductor film 5′ is an amorphous silicon film here and is deposited by, for example, a CVD method. The thickness of the intrinsic semiconductor layer is, for example, 50 nm or more and 200 nm or less, and the thickness of the impurity-doped semiconductor layer is, for example, approximately 40 nm.

### Step 3: Formation of Source Metal Layer, Patterning of Semiconductor Film 5′ (FIGS. 9C and 10C)

Next, a source conductive film (thickness: for example, 50 nm or more and 500 nm or less) is deposited on the semiconductor film 5′. The source conductive film is deposited by, for example, a sputtering method. Next, the semiconductor film 5′ and the source conductive film are patterned by a photolithography process using a multi-tone photomask. As a result, as illustrated in FIGS. 9C and 10C, the semiconductor layer 5 having an island shape, the base semiconductor layer 18, the source electrode 6, the drain electrode 7, the source wiring line SL, and the lower conductive layer 15 are formed. The source electrode 6, the drain electrode 7, the source wiring line SL, and the lower conductive layer 15 are collectively referred to as a “source metal layer”.

As the source conductive film, for example, a metal film including an element selected from aluminum (Al), chromium (Cr), copper (Cu), tantalum (Ta), titanium (Ti), molybdenum (Mo), or tungsten (W), or an alloy film including these elements as components can be used. In addition, a layered film including a plurality of films among these films may be used. Here, a source conductive film including a Ti film as a lower layer and including a Cu film as an upper layer is formed. In this manner, the TFT 2A is completed.

### Step 4: Formation of Intermediate Conductive Layer (FIGS. 9D and 10D)

Next, a transparent conductive film (thickness: for example, 20 nm or more and 300 nm or less) is formed to cover the source metal layer. The transparent conductive film is formed by, for example, a sputtering method. As the material of the transparent conductive film, for example, ITO can be used. The transparent conductive film is then patterned by a photolithography process. As a result, the intermediate conductive layer 16 is formed as illustrated in FIG. 10D.

### Step 5: Formation of Interlayer Insulating Layer 8 and Organic Insulating Layer 9 (FIGS. 9E and 10E)

Next, as illustrated in FIGS. 9E and 10E, the interlayer insulating layer 8 (thickness: for example, 100 nm or more and 500 nm or less) is formed to cover the TFT 2A, and then the organic insulating layer 9 (thickness: for example, 1 to 3 μm) is formed on the interlayer insulating layer 8.

The interlayer insulating layer 8 is formed by, for example, a CVD method. As the interlayer insulating layer 8, a silicon oxide (SiOx) layer, a silicon nitride (SiNx) layer, or the like can be used as appropriate. The interlayer insulating layer 8 may be a single layer, or may include a layered structure.

The organic insulating layer 9 may be formed of, for example, a photosensitive resin material. As the photosensitive resin material, for example, an acrylic resin material can be used.

An uneven surface structure is formed on the surface of a portion of the organic insulating layer 9 which is located in the reflective region. In addition, an opening 9a is formed in the organic insulating layer 9 so as to overlap a portion of the drain electrode 7 when viewed from the normal direction of the substrate 1. Furthermore, the organic insulating layer 9 is not formed in the terminal portion formation region.

A process of forming the organic insulating layer 9 includes, for example, a process of applying a photosensitive resin material onto the interlayer insulating layer 8, a process of pattern-exposing the applied photosensitive resin material with the use of a multi-tone photomask, a process of developing the pattern-exposed photosensitive resin material, and a process of performing baking after development.

### Step 6: Formation of Openings 8a and 8b in Interlayer Insulating Layer 8 (FIGS. 9F and 10F)

Next, as illustrated in FIGS. 9F and 10F, openings 8a and 8b are formed in the interlayer insulating layer 8 by a photolithography process. Specifically, the opening 8a is formed in interlayer insulating layer 8 to expose a portion of the drain electrode 7 in the TFT formation region, and the opening 8b is formed in interlayer insulating layer 8 to expose a portion of the intermediate conductive layer 16 in the terminal portion formation region.

### Step 7: Formation of First Transparent Electrode TE1 and the Like (FIGS. 9G and 10G)

Thereafter, a transparent conductive film (thickness: for example, 20 nm or more and 300 nm or less) is formed on the organic insulating layer 9. The transparent conductive film is formed by, for example, a sputtering method. As the material of the transparent conductive film, for example, ITO can be used. Next, the transparent conductive film is patterned by a photolithography process. As a result, the first transparent electrode TE1 and the upper conductive layer 17 are formed on the organic insulating layer 9 as illustrated in FIGS. 9G and 10G.

### Step 8: Formation of Reflective Electrode RE and Second Transparent Electrode TE2 (FIGS. 9H and 10H)

Next, a conductive film (thickness: for example, 50 nm or more and 300 nm or less) and a transparent conductive film (thickness: for example, 20 nm or more and 300 nm or less) are successively formed on the first transparent electrode TEL and the organic insulating layer 9. The conductive film and the transparent conductive film are formed by, for example, a sputtering method. Next, the conductive film and transparent conductive film are patterned by a photolithography process. As a result, as illustrated in FIG. 9H, the reflective electrode RE and the second transparent electrode TE2 are formed on a portion of the first transparent electrode TEL which is located in the reflective region. The conductive film for forming the reflective electrode RE is, for example, an Al film, an Al alloy film, an Ag film, or an Ag alloy film. As the material of the transparent conductive film for forming the second transparent electrode TE2, for example, ITO can be used.

In this manner, the TFT substrate 10 is prepared. The process of preparing the counter substrate 20 and the process of forming the liquid crystal layer 30 may be performed using various known techniques, and thus, descriptions thereof will be omitted herein.

According to the above-described manufacturing method, the semiconductor film 5′ and the source conductive film are simultaneously patterned by a photolithography process using a multi-tone photomask, and thus, the number of masks can be reduced. Further, in the process of forming the organic insulating layer 9, pattern exposure using a multi-tone photomask is performed, whereby the number of masks can also be reduced. In the illustrated manufacturing method, the TFT substrate 10 can be manufactured using eight photomasks.

A reflective liquid crystal display device has been described as an example in the description above. However, the liquid crystal display device according to embodiments of the disclosure is not limited to a reflective type. The liquid crystal display device according to the embodiments of the disclosure may be a transmissive/reflective type (transflective type). In a transmissive/reflective liquid crystal display device, each pixel P includes, in addition to a reflective region, a transmissive region in which light emitted from a backlight (illumination device) is used to perform display in a transmission mode.

### INDUSTRIAL APPLICABILITY

According to an embodiment of the disclosure, in a liquid crystal display device in which each pixel includes a reflective region, it is possible to curb damage to a terminal portion caused by an etchant for forming a reflective electrode.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
a first substrate;
a second substrate facing the first substrate; and
a liquid crystal layer provided between the first substrate and the second substrate,
wherein the liquid crystal display device includes a display region including a plurality of pixels arranged in a matrix including a plurality of rows and a plurality of columns, and a non-display region located around the display region,
each of the plurality of pixels includes a reflective region in which display is performed in a reflection mode,
the first substrate includes
a thin film transistor provided in each of the plurality of pixels,
a transparent electrode electrically connected to the thin film transistor,
a reflective electrode provided on a portion of the transparent electrode, the portion being located in the reflective region, and
a terminal portion disposed in the non-display region,
the thin film transistor includes
a semiconductor layer including a channel region, and a source region and a drain region located on both sides of the channel region,
a gate electrode facing the channel region via a gate insulating layer,
a source electrode electrically connected to the source region of the semiconductor layer, and
a drain electrode electrically connected to the drain region of the semiconductor layer,
the terminal portion includes
a lower conductive layer formed in the same layer as the gate electrode,
an intermediate conductive layer formed of a transparent conductive material and covering the lower conductive layer, and
an upper conductive layer formed in the same layer as the transparent electrode, and
the terminal portion does not include a conductive layer formed in the same layer as the source electrode and the drain electrode.

2. The liquid crystal display device according to claim 1,
wherein the thin film transistor further includes a protective conductive layer formed in the same layer as the intermediate conductive layer and covering the gate electrode.

3. The liquid crystal display device according to claim 1,
wherein the first substrate further includes
an interlayer insulating layer covering the thin film transistor, and
an organic insulating layer provided on the interlayer insulating layer,
the transparent electrode is provided on the organic insulating layer,
a first contact hole exposing a portion of the drain electrode is formed in the interlayer insulating layer and the organic insulating layer, and
the transparent electrode is connected to the drain electrode in the first contact hole.

4. The liquid crystal display device according to claim 3,
wherein the gate electrode is disposed below the semiconductor layer,
a second contact hole exposing a portion of the intermediate conductive layer is formed in the gate insulating layer and the interlayer insulating layer, and
the upper conductive layer is connected to the intermediate conductive layer in the second contact hole.

5. The liquid crystal display device according to claim 3,
wherein a portion of the organic insulating layer which is located in the reflective region has an uneven surface structure, and
each of the reflective electrode and the portion of the transparent electrode which is located in the reflective region has an uneven surface structure reflecting the uneven surface structure of the organic insulating layer.

6. The liquid crystal display device according to claim 1,
wherein the first substrate further includes a transparent electrode provided on the reflective electrode.

7. A liquid crystal display device comprising:
a first substrate;
a second substrate facing the first substrate; and
a liquid crystal layer provided between the first substrate and the second substrate,
wherein the liquid crystal display device includes a display region including a plurality of pixels arranged in a matrix including a plurality of rows and a plurality of columns, and a non-display region located around the display region,
each of the plurality of pixels includes a reflective region in which display is performed in a reflection mode,
the first substrate includes
a thin film transistor provided in each of the plurality of pixels,
a transparent electrode electrically connected to the thin film transistor,
a reflective electrode provided on a portion of the transparent electrode, the portion being located in the reflective region, and
a terminal portion disposed in the non-display region,
the thin film transistor includes
a semiconductor layer including a channel region, and a source region and a drain region located on both sides of the channel region,
a gate electrode facing the channel region via a gate insulating layer,
a source electrode electrically connected to the source region of the semiconductor layer, and
a drain electrode electrically connected to the drain region of the semiconductor layer,
the terminal portion includes
a lower conductive layer formed in the same layer as the source electrode and the drain electrode,
an intermediate conductive layer formed of a transparent conductive material and covering the lower conductive layer, and
an upper conductive layer formed in the same layer as the transparent electrode, and
the terminal portion does not include a conductive layer formed in the same layer as the gate electrode.

8. The liquid crystal display device according to claim 7,
wherein the terminal portion includes a base semiconductor layer formed in the same layer as the semiconductor layer and located below the lower conductive layer.

9. The liquid crystal display device according to claim 7,
wherein the first substrate further includes
an interlayer insulating layer covering the thin film transistor, and
an organic insulating layer provided on the interlayer insulating layer,
the transparent electrode is provided on the organic insulating layer,
a first contact hole exposing a portion of the drain electrode is formed in the interlayer insulating layer and the organic insulating layer, and
the transparent electrode is connected to the drain electrode in the first contact hole.

10. The liquid crystal display device according to claim 9,
wherein a second contact hole exposing a portion of the intermediate conductive layer is formed in the interlayer insulating layer, and
the upper conductive layer is connected to the intermediate conductive layer in the second contact hole.

11. The liquid crystal display device according to claim 9,
wherein a portion of the organic insulating layer which is located in the reflective region has an uneven surface structure, and
each of the reflective electrode and the portion of the transparent electrode which is located in the reflective region has an uneven surface structure reflecting the uneven surface structure of the organic insulating layer.

12. The liquid crystal display device according to claim 7,
wherein the first substrate further includes a transparent electrode provided on the reflective electrode.

13. A manufacturing method for the liquid crystal display device according to claim 1,
wherein preparing the first substrate includes
(a) forming the thin film transistor on a substrate,
(b) forming an interlayer insulating layer covering the thin film transistor,
(c) forming an organic insulating layer on the interlayer insulating layer,
(d) forming the transparent electrode on the organic insulating layer, and
(e) forming the reflective electrode on a portion of the transparent electrode, the portion being located in the reflective region, and
(a) forming the thin film transistor includes
(a1) depositing a semiconductor film on the gate insulating layer,
(a2) depositing a source conductive film on the semiconductor film, and
(a3) forming the semiconductor layer, the source electrode, and the drain electrode by patterning the semiconductor film and the source conductive film by a photolithography process using a multi-tone photomask.

14. The manufacturing method according to claim 13,
wherein the organic insulating layer is provided with an opening overlapping a portion of the drain electrode,
a portion of the organic insulating layer which is located in the reflective region has an uneven surface structure, and
(c) forming the organic insulating layer includes
(c1) applying a photosensitive resin material onto the interlayer insulating layer,
(c2) pattern-exposing the photosensitive resin material having been applied, using a multi-tone photomask, and
(c3) developing the photosensitive resin material having been pattern-exposed.

15. The manufacturing method according to claim 13,
wherein (a) forming the thin film transistor further includes (a4) forming the gate electrode,
the lower conductive layer of the terminal portion is formed together with the gate electrode in (a4) forming the gate electrode, and
the upper conductive layer of the terminal portion is formed together with the transparent electrode in (d) forming the transparent electrode.

16. The manufacturing method according to claim 15,
wherein (a) forming the thin film transistor further includes (a5) forming a protective conductive layer covering the gate electrode, and
the intermediate conductive layer of the terminal portion is formed together with the protective conductive layer in (a5) forming the protective conductive layer.

17. A manufacturing method for the liquid crystal display device according to claim 7,
wherein preparing the first substrate includes
(a) forming the thin film transistor on a substrate,
(b) forming an interlayer insulating layer covering the thin film transistor,
(c) forming an organic insulating layer on the interlayer insulating layer,
(d) forming the transparent electrode on the organic insulating layer, and
(e) forming the reflective electrode on a portion of the transparent electrode, the portion being located in the reflective region, and
(a) forming the thin film transistor includes
(a1) depositing a semiconductor film on the gate insulating layer,
(a2) depositing a source conductive film on the semiconductor film, and
(a3) forming the semiconductor layer, the source electrode, and the drain electrode by patterning the semiconductor film and the source conductive film by a photolithography process using a multi-tone photomask.

18. The manufacturing method according to claim 17,
wherein the organic insulating layer is provided with an opening overlapping a portion of the drain electrode,
a portion of the organic insulating layer which is located in the reflective region has an uneven surface structure, and
(c) forming the organic insulating layer includes
(c1) applying a photosensitive resin material onto the interlayer insulating layer,
(c2) pattern-exposing the photosensitive resin material having been applied, using a multi-tone photomask, and
(c3) developing the photosensitive resin material having been pattern-exposed.

19. The manufacturing method according to claim 17,
wherein the lower conductive layer of the terminal portion is formed together with the source electrode and the drain electrode in (a3) forming the semiconductor layer, the source electrode, and the drain electrode, and
the upper conductive layer of the terminal portion is formed together with the transparent electrode in (d) forming the transparent electrode.

20. The manufacturing method according to claim 17, further comprising:
(f) forming the intermediate conductive layer of the terminal portion after (a) forming the thin film transistor.
